(19) United States
(12) Patent Application Publication
(10) Pub. No.: US 2009/0289503 A1
(43) Pub. Date: Nov. 26, 2009

(54) ILLUMINATION CONTROL SYSTEM

(75) Inventors: Kouji Hayashi, Ome-shi (JP); Takashi Minemura, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/415,785

(22) Filed: Mar. 31, 2009

(30) Foreign Application Priority Data
May 22, 2008 (JP) 2008-134582

(51) Int. Cl. H02J 7/00

(52) U.S. Cl. 307/66; 320/101

(57) ABSTRACT

According to one embodiment, an illumination control system controlling remotely an illumination device comprises a signal detection module configured to detect a control signal from a remote controller with a rectification circuit to which a bias voltage is applied, a switch control module configured to turn a switch of the illumination device on or off in accordance with the detected signal, an energy receiving module configured to receive energy from external environment and to convert the energy into electrical energy, an internal battery configured to store the converted electrical energy, and a power supply module configured to supply drive voltage for the signal detection module and the bias voltage from the converted electrical energy or from the electrical energy stored in the internal battery.

### CROSS-REFERENCE TO RELATED APPLICATIONS

This application is based upon and claims the benefit of priority from Japanese Patent Application No. 2008-134582, filed May 22, 2008, the entire contents of which are incorporated herein by reference.

### BACKGROUND

1. Field

One embodiment of the invention relates to an illumination control system based on remote control.

2. Description of the Related Art

Remote control of electrical equipment using wireless communication, optical communication, infrared communication or the like has hitherto been carried out. In the remote control of electrical equipment, a signal transmitted from a remote controller is received by a receiving unit in the electrical equipment, and operation corresponding to the received signal is performed. As the receiving unit in the electrical equipment has to be constantly on standby for a signal from the remote controller, the receiving unit has to be always powered by a power source. Therefore, a great amount of energy is consumed for the receiving unit to be on standby for a signal.

Jpn. Pat. Appln. KOKAI Publication No. 2001-157273 discloses a technique of saving power for remote control of electrical equipment. In this electrical equipment, a remote-control receiving unit receives a wireless remote-control signal from a remote-control transmission unit and converts the signal into an electrical control signal, whereby the equipment is controlled. A solar battery is provided to operate the remote-control receiving unit. This solar battery supplies output power to the remote-control receiving unit, and also charges a secondary battery. The receiving unit is thus energized by the solar battery, so that there is no longer a need to supply power to the receiving unit from a power source such as a commercial alternating current power source.

According to the above technique of saving power, a solar battery is utilized as the buttery to drive the receiving unit. Therefore, consumption of power supplied from the commercial alternating current power source can be reduced. However, the power consumed by the receiving unit is not reduced. In specific, a typical receiving unit which uses a low-noise amplifier consumes a large amount of power. Therefore, the electrical equipment needs a solar panel which is large enough to cover the power consumption required to stand by for a signal. Accordingly, a size of the electrical equipment should be large and the cost to provide the large solar battery will be high.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a configuration of an illumination control system according to an embodiment of the present invention;

FIG. 2 is an exemplary block diagram showing an example of a configuration of a remote controller for illumination control;

FIG. 3 is an exemplary view showing an example of appearance of the remote controller;

FIG. 4 is an exemplary view of the illumination control system in which a photoelectric conversion element is used as an external energy receiver;

FIG. 5 is an exemplary view of the illumination control system in which a charging antenna and a rectification circuit are used as the external energy receiver;

FIG. 6 is an exemplary view of the illumination control system in which an LC parallel resonance circuit is used as the charging antenna;

FIG. 7 is an exemplary view of the illumination control system in which a half- or quarter-wavelength antenna conductor is used as the charging antenna;

FIG. 8 is an exemplary view of the illumination control system in which an antenna, a variable matching circuit and the rectification circuit are used as the external energy receiver;

FIG. 9 is an exemplary view showing an example of the external energy receiver provided in the vicinity of an illumination device;

FIG. 10 is an exemplary view showing another example of the external energy receiver provided in the vicinity of the illumination device;

FIG. 11 is an exemplary view showing a configuration of the illumination control system according to a first modification;

FIG. 12 is an exemplary view showing a configuration of the illumination control system according to a third modification;

FIG. 13 is an exemplary view showing a configuration of the illumination control system according to a fourth modification; and

FIG. 14 is an exemplary view showing a configuration of the illumination control system according to a fifth modification.

### DETAILED DESCRIPTION

Various embodiments according to the invention will be described hereinafter with reference to the accompanying drawings. In general, according to one embodiment of the invention, an illumination control system controlling remotely an illumination device comprises a signal detection module configured to detect a control signal from a remote controller with a rectification circuit to which a bias voltage is applied, a switch control module configured to turn a switch of the illumination device on or off in accordance with the signal detected by the signal detection module, an energy receiving module configured to receive energy from external environment and to convert the energy into electrical energy, an internal battery configured to store the electrical energy converted by the energy receiving module, and a power supply module configured to supply drive voltage for the signal detection module and the bias voltage from the electrical energy converted by the energy receiving module or from the electrical energy stored in the internal battery.

Hereinafter, embodiments of an illumination control system according to the present invention will be described with reference to the drawings.

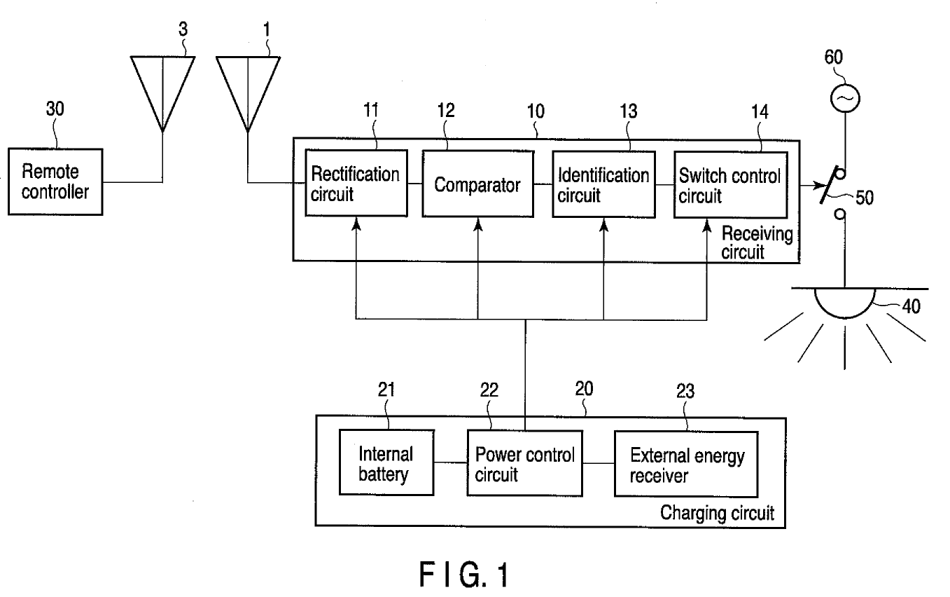

FIG. 1 is an exemplary view showing a configuration of the illumination control system according to an embodiment of the present invention.

The illumination control system includes a receiving circuit module 10, a charging circuit module 20, a remote controller 30 for illumination control, an illumination device 40, a switch 50 and an AC power source 60.

Although one receiving circuit module 10, one illumination device 40, one switch 50 and one AC power source 60 are shown in FIG. 1, the number of each of them to be provided may be greater than one. In the case where pluralities of such components are provided, each receiving circuit module 10 and each illumination device 40 correspond one to one and connected to each other by corresponding switch 50.

The illumination device 40 includes an electric lamp such as a fluorescent light, an incandescent light, a mercury lamp or a sodium lamp. The illumination device 40 has a unique ID. The remote controller 30 transmits via an antenna 3 a control signal to instruct turning the illumination device 40 on or off. When a plurality of illumination devices 40 are controlled by one remote controller 30, the remote controller 30 can select an illumination device 40 to be targeted for control. The control signal also includes information indicating an ID which is unique to the selected illumination device 40. The transmitted control signal is received by an antenna 1, and sent to the receiving circuit module 10. The transmission and reception of the control signal may be carried out by wireless communication. Alternatively, the transmission and reception of the control signal may be carried out by optical communication, infrared communication or the like. The receiving circuit module 10 turns the switch 50 on or off in accordance with the received control signal, and controls turning the illumination device 40 on and off. Power for driving each component of the receiving circuit module 10 is supplied from the charging circuit module 20.

The receiving circuit module 10 comprises a rectification circuit 11, a comparator 12, an identification circuit 13 and a switch control circuit 14. Drive voltage for driving these components is provided from the charging circuit module 20.

The rectification circuit 11 is a circuit for converting a radio frequency into a direct current. A predetermined threshold voltage V1 is set for the rectification circuit 11, and it is detected whether or not a signal having intensity greater than or equal to V1 is received. A bias voltage V2 is also applied to the rectification circuit 11 from the charging circuit module 20. In general, the rectification circuit only rectifies a received signal and hardly consumes power during standby for a signal. Employing the rectification circuit for a signal receiving circuit module can eliminate the need to run a bias current during standby for a signal. Therefore, during standby, standby power requirement can be ideally zero. On the contrary, a conventional wireless circuit typically uses a low-noise amplifier on a first stage to improve sensitivity, and a bias current always needs to pass through the low-noise amplifier to keep on standby for a signal. Thus, power is generated even during standby. In the present embodiment, the bias voltage V2 is previously applied to a diode in the rectification circuit 11 to enhance the sensitivity of the rectification circuit 11. Owing to the bias voltage V2, even when intensity D of a signal received by the antenna 1 is low, the signal can be detected when the sum of the signal intensity D and the bias voltage V2 is great enough to exceed the threshold voltage V1 of a transistor, and higher sensitivity can be obtained.

For example, a signal of 0.1 V or more can be detected provided that V1=0.7 V and V2=0.6 V. Thus, even when the control signal transmitted from the remote controller 30 is weak, the signal can be received. Almost no power (no more than a leakage current of a semiconductor) is consumed to apply the bias voltage V2.

The control signal detected by the rectification circuit 11 is output to the comparator 12. The comparator 12 converts the received control signal into a binary signal having a high or low level. A predetermined threshold voltage V3 is set for the comparator 12. When the control signal from the rectification circuit 11 is greater than or equal to V3, the comparator 12 outputs a signal of high level. The comparator 12 outputs a signal of low level when the control signal is less than V3.

The identification circuit 13 extracts ID information contained in the control signal binarized by the comparator 12, and determines whether or not the extracted ID matches the ID of the illumination device 40 which corresponds to the receiving circuit module 10. The switch control circuit 14 turns the switch 50 on or off in accordance with the control signal only when the IDs match. Then, the illumination device 40 turns on or off in accordance with the turning on or off of the switch 50.

As described above, in the present embodiment, the rectification circuit 11, for which the threshold voltage is reduced by applying the bias voltage, is used at the first stage of the receiving circuit module 10. The rectification circuit 11 is only required to operate when a radio signal is received. Thus, power consumption can be lower during waiting for a signal than in an ordinary receiving unit using a low-noise amplifier or the like. Moreover, even a weak radio signal from the remote controller 30 can be detected.

The charging circuit module 20 functions as a power source for driving the receiving circuit module 10. The bias voltage V2 applied to the rectification circuit 11 is also provided from the charging circuit module 20. The charging circuit module 20 includes an internal battery 21, a power control circuit 22 and an external energy receiver 23.

The internal battery 21 is an element having a charge storage function. The internal battery 21 may be a rechargeable battery such as a nickel metal-hydride battery. Alternatively, the internal battery 21 may be a non-interchangeable part such as a super-capacitor. The power control circuit 22 controls the whole of the charging circuit module 20. Further, the external energy receiver 23 receives light energy, electromagnetic energy or thermal energy from the external environment and converts the received energy into electrical energy.

The electrical energy converted by the external energy receiver 23 can be stored in the internal battery 21 and the internal battery 21 charges with the electrical energy. The power control circuit 22 drives components of the receiving circuit module 10 by the power supplied from the external energy receiver 23 or the internal battery 21.

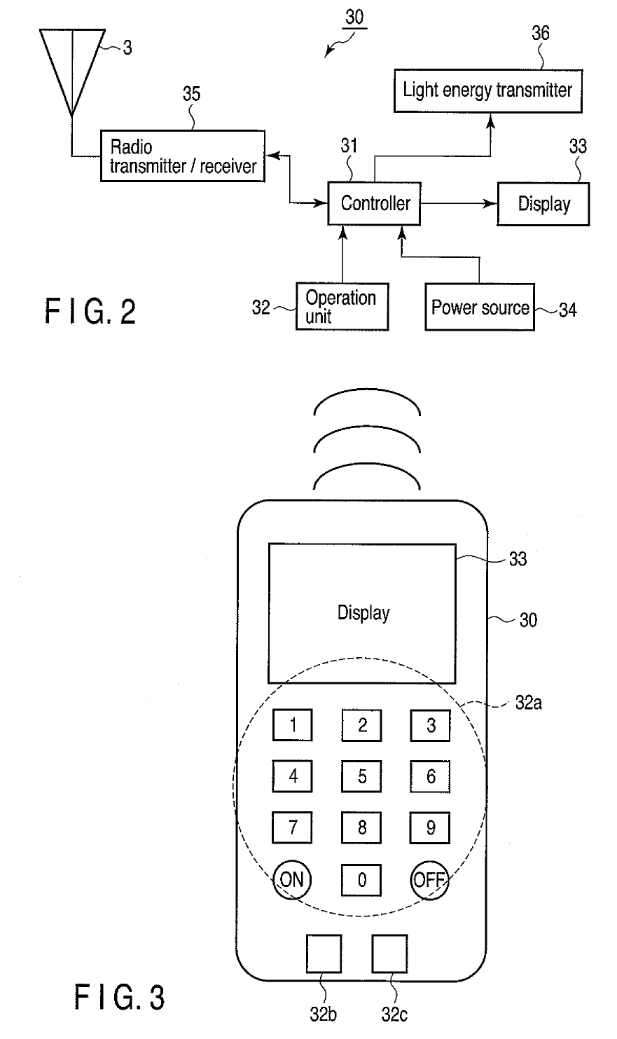

FIG. 2 is an exemplary block diagram showing an example of a circuit configuration of the remote controller 30 for illumination control. FIG. 3 is an exemplary view showing an example of appearance of the remote controller 30 for illumination control.

The remote controller 30 includes a controller section 31, an operating section 32, a display 33, a power source 34 and a radio transmitter/receiver 35. Instead of or in addition to the radio transmitter/receiver 35, the remote controller 30 may include a light energy transmitter 36. In this case, the receiving circuit module 10 may also include a light energy receiver.

As shown in FIG. 3, the operating section 32 includes operation button group 32a. A user of the remote controller 30 inputs an ID of the illumination device 40 to be controlled and an instruction to turn the light on or off by operating the operation button group 32a. In some embodiments, the operating section 32 may comprise a light energy transmission button 32b and/or a wireless power transmission button 32c. An operation signal generated from the operation of the operating section 32 is sent to the controller section 31, and processing corresponding to the operation signal will be performed.

The display 33 comprises, for example, a liquid crystal display, and displays, for example, the ID input by the operation of the operating section 32.

The power source 34 comprises, for example, an internal dry battery or a rechargeable battery, and supplies power required for the operation of the remote controller 30.

The radio transmitter/receiver 35 transmits a radio signal under the control of the controller section 31. When the ID of the illumination device 40 and an instruction to turn the light on or off are input with the operation of the operation button group 32a, the radio transmitter/receiver 35 transmits a control signal including the ID of the illumination device 40 targeted for control and the instruction to turn the light on or off via the antenna 3. As described later, the radio transmitter/receiver 35 may be configured to transmit power to the external energy receiver 23 by a radio signal in response to operation of the wireless power transmission button 32c.

The above-mentioned control signal may be transmitted from the light energy transmitter 36. For example, when the remote controller 30 does not comprise the radio transmitter/receiver 35 or when the radio transmitter/receiver 35 cannot be used for some reason, the light energy transmitter 36 will be used. When using the light energy transmitter 36, the illumination device 40 can be controlled by optical communication or infrared communication. Moreover, the light energy transmitter 36 may be configured to transmit light energy to the external energy receiver 23 in response to the operation of the light energy transmission button 32b as will be described later.

As described above, since the bias voltage V2 is applied to the rectification circuit 11, the control signal can be received even when the control signal transmitted from the remote controller 30 is weak. When the ID contained in the detected control signal matches the ID of the illumination device 40 corresponding to the receiving circuit module 10, the switch 50 is turned on and the illumination device 40 is also turned on. Moreover, electric power for driving each component of the receiving circuit module 10 is supplied from the charging circuit module 20. The charging circuit module 20 uses the energy absorbed by the external energy receiver 23 from the external environment. Therefore, there is no need to further provide a power source device and power can be saved. Further, since the power consumption of the receiving circuit module 10 is reduced by disposing the rectification circuit 11 at the first stage of the receiving circuit module 10, the external energy receiver 23 need not receive so high external energy. Thus, the size of the external energy receiver 23 may be small.

Furthermore, a unique ID is allocated to each illumination device. Therefore, even when plural illumination devices 40 are provided, one remote controller 30 can intensively control the illumination devices.

Next, energy reception from the external environment by the external energy receiver 23 will be described.

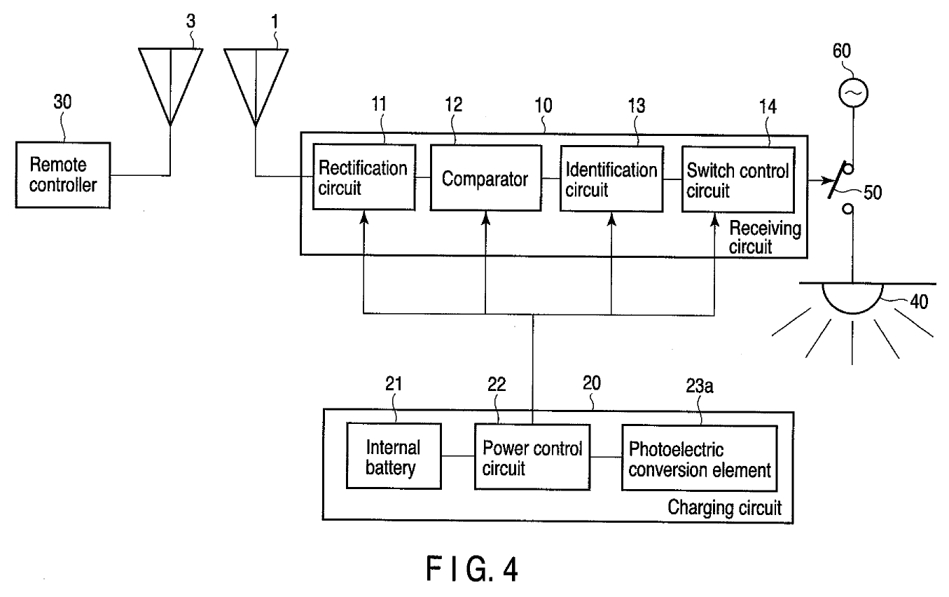

FIG. 4 is an exemplary view of the illumination control system in which a photoelectric conversion element 23a is used as the external energy receiver 23. The photoelectric conversion element 23a converts energy of light into electrical energy. Thus, light emitted from the illumination device 40 can be absorbed, and energy of this light can be converted into electric power for driving the receiving circuit module 10. Consequently, energy can be efficiently reused. Moreover, the configuration of the charging circuit module 20 can be simple. A photodiode or a solar battery may be used as the photoelectric conversion element 23a.

The external energy absorbed from the external environment is not limited to the light energy. It is also possible to absorb electromagnetic energy from electromagnetic radiation in the external environment.

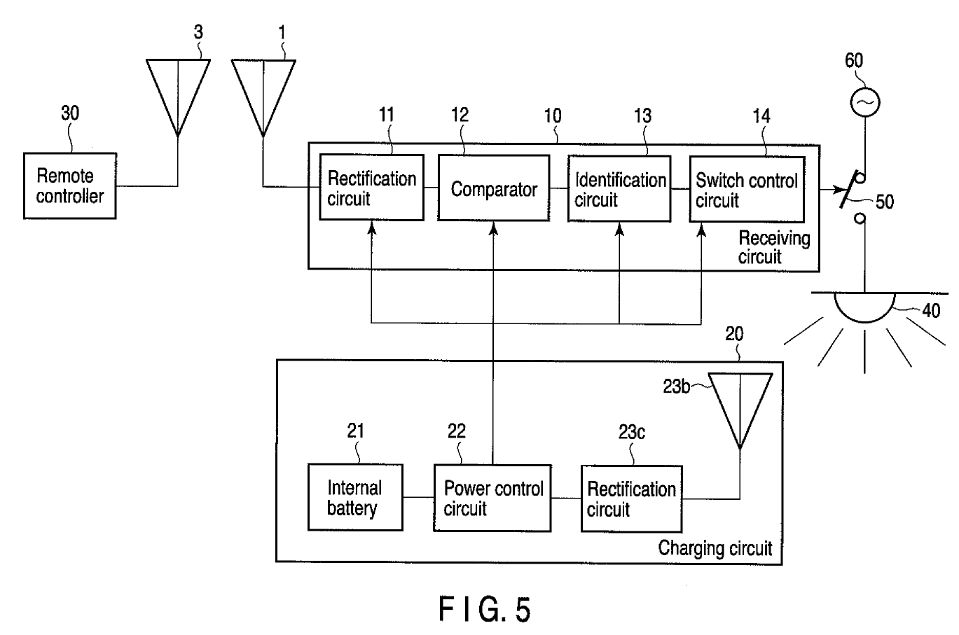

FIG. 5 is an exemplary view of the illumination control system in which a charging antenna 23b and a rectification circuit 23c are used as the external energy receiver 23. In the charging circuit module 20 shown in FIG. 5, electromagnetic radiation in the external environment received by the antenna 23b is converted into a direct current by the rectification circuit 23c.

For example, in the case where the illumination device 40 comprises an inverter-type fluorescent light, excess electromagnetic radiation (noise) may be emitted from the inverter. According to the charging circuit module shown in FIG. 5, such excess electromagnetic radiation emitted from the illumination device 40 can also be absorbed as external energy. Therefore, it is possible to efficiently reuse the energy of the excess electromagnetic radiation.

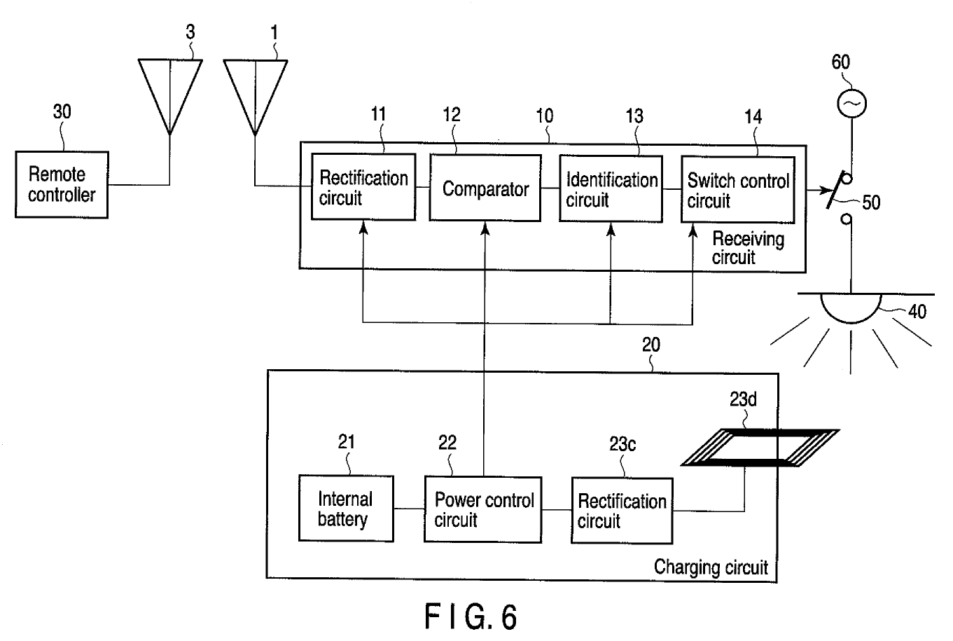

As the charging antenna 23b, an LC (inductance-capacitance) parallel resonance circuit 23d may be used as shown in FIG. 6. By means of the LC parallel resonance circuit 23d, receiving electromagnetic radiation of low frequencies comes to be possible. In the case where a helical antenna is used as an inductor L, detection of a magnetic field is especially facilitated.

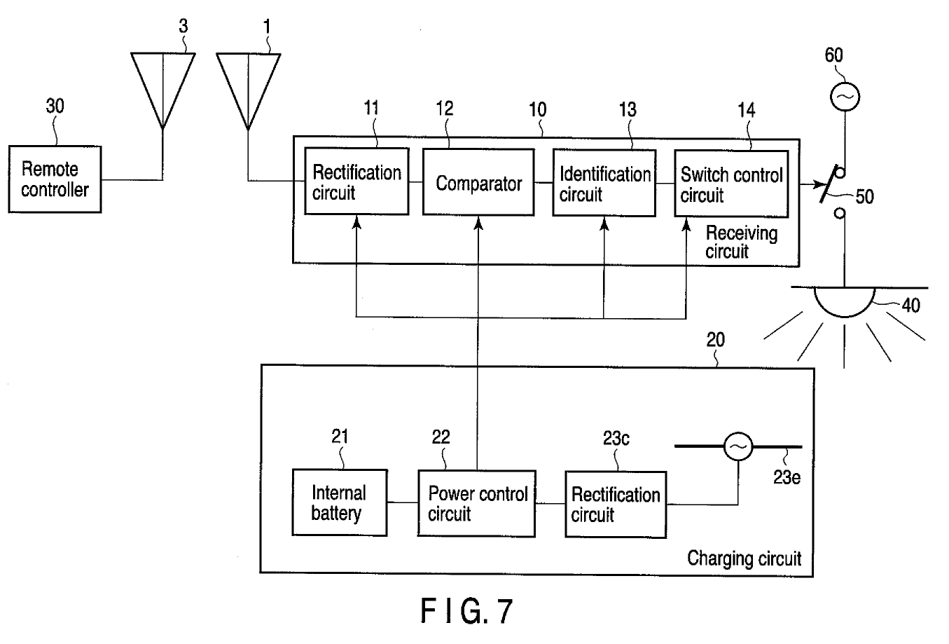

Furthermore, as the charging antenna 23b, a half-wavelength antenna conductor 23e may be used, as shown in FIG. 7. By use of an antenna which is adjusted to a resonant frequency enables efficient electromagnetic wave noise reception and facilitates detection of a electric field. Further downsizing can be realized by use of a quarter-wavelength antenna conductor.

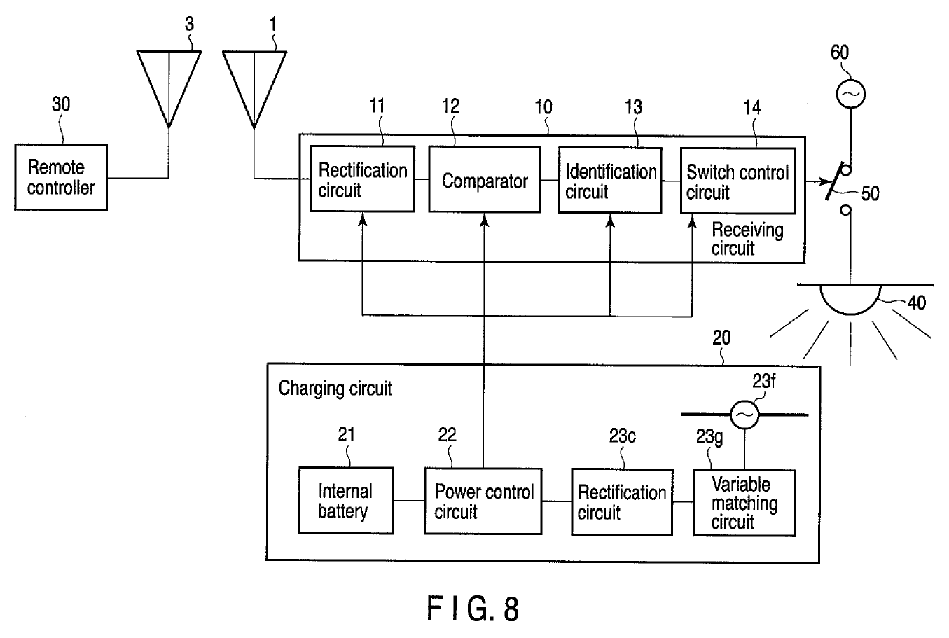

FIG. 8 is an exemplary view of the illumination control system in which an antenna 23f, a variable matching circuit 23g and the rectification circuit 23c are used as the external energy receiver 23. Even when a frequency of the electromagnetic wave noise generated from the illumination device 40 varies, the resonant frequency can be changed by the variable matching circuit 23g. Thus, the electromagnetic wave noise serving as a charging source can be received with good sensitivity.

As described above, the external energy obtained by the external energy receiver 23 includes energy of light, electromagnetic radiation or the like generated from the illumination device 40. Therefore, it is not necessary to externally provide power for standby, and power can be saved.

In order to efficiently absorb the energy of light or energy of electromagnetic radiation generated from the illumination device 40, it is desirable that the external energy receiver 23 is provided as close to the illumination device 40 as possible.

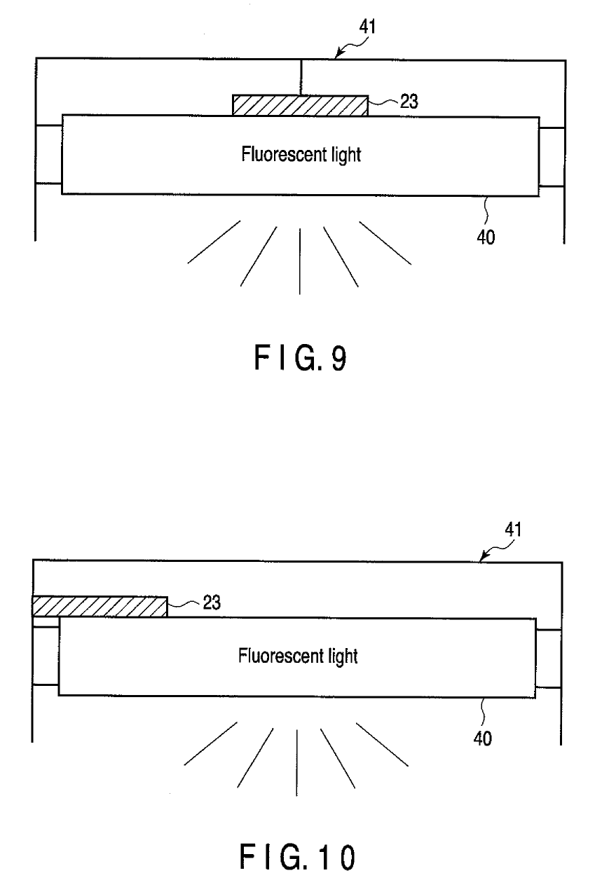

FIGS. 9 and 10 are views showing examples of the external energy receiver 23 provided in the vicinity of the illumination device 40. In FIGS. 9 and 10, a fluorescent light is used as the illumination device 40 and a reflecting plate 41 is provided above the fluorescent light. As shown, when the external energy receiver 23 such as a solar battery is arranged between the reflecting plate 41 and the fluorescent light 40, light from the fluorescent light 40 and light reflected by the reflecting plate 41 can be received without blocking the light from the fluorescent light 40. Consequently, efficient energy acquisition can be achieved.

It is also possible to use a photo-rechargeable battery as the external energy receiver 23. The photo-rechargeable battery is capable of storing converted electrical energy; therefore, it will not be necessary to provide the internal battery 21.

Explained below is an example and associated effects of a difference of power consumption between cases (i) in which a conventional and typical low-noise amplifier operating intermittently is used in the receiving circuit module and (ii) in which the rectification circuit 11 according to the present embodiment is used, in the remote control of the fluorescent light 40 according to the present embodiment. To be specific, a difference of available time between the case of (i) and the case of (ii) according to the present embodiment will be shown when a general-purpose super-capacitor is used as the internal battery 21.

Power consumption during standby is generally about 500 μAh in the case where the conventional low-noise amplifier is used in the receiving circuit. When super-capacitors having capacitances of 0.047, 0.1, 0.22, 10, 22 and 50 F are used for the internal battery 21, times through which the current of 500 μA necessary for standby can be passed are about 94 seconds for 0.047 F, about 200 seconds for 0.1 F, about 440 seconds for 0.22 F, about 5.5 hours for 10 F, about 12 hours for 22 F, and about 27 hours for 50 F.

On the other hand, when the rectification circuit 11 according to the present embodiment is used, power consumption for standby is about 2 μAh. When the super-capacitors having capacitances of 0.047, 0.1, 0.22, 10, 22 and 50 F are used as the internal battery 21 as in the case described above, times through which 2 μA necessary for standby can be passed are about 6.5 hours for 0.047 F, about 14 hours for 0.1 F, about 30 hours for 0.22 F, about 1400 hours for 10 F, about 3000 hours for 22 F, and about 7000 hours for 50 F.

That is, the use of the rectification circuit 11 according to the present embodiment increases the time that enables the supply of electric power necessary for standby.

In addition, the present invention is not limited the embodiment described above, and various modifications can be made as described below.

### First Modification

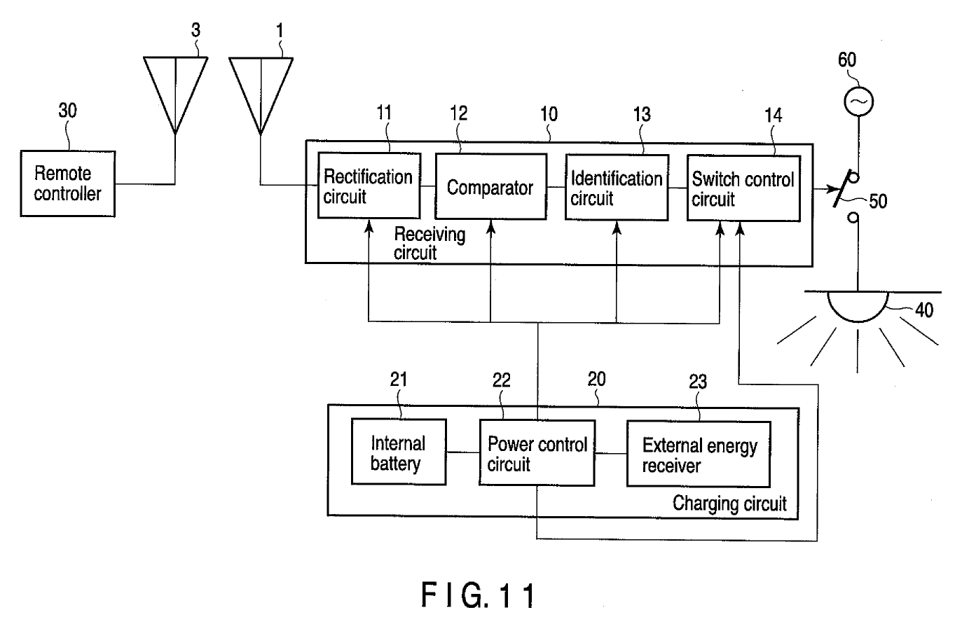

FIG. 11 is an exemplary view showing a configuration of the illumination control system according to a first modification. As shown in FIG. 11, in the present modification, the power control circuit 22 of the charging circuit module 20 is electrically connected to the switch control circuit 14 of the receiving circuit module 10.

Even when the illumination device 40 is in an off-state, standby power is supplied from the internal battery 21 to the receiving circuit module 10. Although the amount of this standby power is small, the amount of remaining energy of the internal battery 21 continues to decrease and the internal battery 21 may finally be exhausted if the off-state extends for a long time. At this point, the illumination device 40 is also turned off, so that it is not possible for the external energy receiver 23 to receive energy from the external environment. Then, the internal battery 21 is made usable in the following manner.

The voltage of the internal battery 21 is detected by a voltmeter incorporated in the power control circuit 22. The power control circuit 22 sends a control signal to the switch control circuit 14 when voltage lower than a predetermined value is detected. The switch control circuit 14 turns on the switch 50 in response to the control signal, and the illumination device 40 is automatically turned on for a given period.

When the illumination device 40 is turned on, the light energy or electromagnetic energy from the illumination device 40 is converted into electrical energy by the external energy receiver 23 and the internal battery 21 can be charged again. Thus, the given period in which the illumination device 40 keeps turned on is set to be a period sufficient for the internal battery 21 to be charged.

As described above, according to the first modification, when decrease in the amount of remaining energy of the internal battery 21 is detected, the illumination device 40 is automatically turned on, and the internal battery 21 is charged. Consequently, the inconvenience of charging the internal battery 21 or exchanging the battery with a charged battery can be saved, thus enabling long-term use.

### Second Modification

When the internal battery 21 is completely discharged and inoperative, the internal battery 21 can be restored in the following manner.

As shown in FIG. 3, the operating section 32 of the remote controller 30 is provided with both or one of the light energy transmission button 32b and the wireless power transmission button 32c.

When the user operates the light energy transmission button 32b, light is emitted from the light energy transmitter 36 for a given time. The emitted light is received by the external energy receiver 23 and converted into electrical energy; therefore, the internal battery 21 can be charged again.

Furthermore, when the user operates the wireless power transmission button 32c, a radio signal for charging is transmitted from the radio transmitter/receiver 35 via the antenna 3 for a given time. This radio signal is received by the external energy receiver 23 and converted into electrical energy, then, the internal battery 21 can be charged again.

The operating section 32 may be provided with one of the light energy transmission button 32b and the wireless power transmission button 32c depending on a kind of external energy the external energy receiver 23 can converts. Light emitted from the light energy transmitter 36 is only required to be strong enough to charge the internal battery 21, and may be any light such as laser light or infrared light. In the case where the external energy receiver 23 can obtain energy from electromagnetic radiation other than light, the electromagnetic radiation other than light may be emitted.

As described above, according to the second modification, electric power is transmitted from the remote controller 30 to the external energy receiver 23 for a given time by light or by radio and the internal battery 21 can be charged. Thus, the internal battery 21 can be restored from the completely discharged inactive state to a usable state.

### Third Modification

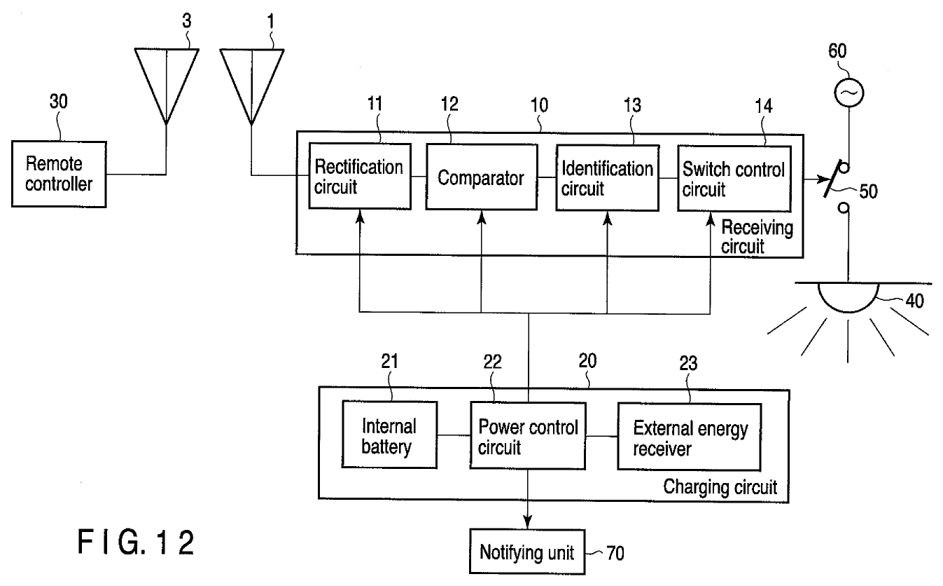

FIG. 12 is an exemplary view showing a configuration of the illumination control system according to a third modification. As shown in FIG. 12, in the present modification, the power control circuit 22 of the charging circuit module 20 is electrically connected to a notifying module 70.

When it is detected that voltage is decreased below a predetermined value because of decrease in the amount of remaining energy of the internal battery 21, the power control circuit 22 transmits a notification signal to the notifying module 70. The notifying module which has received the notification signal notifies the user about the decrease in the amount of remaining energy of the internal battery 21.

The notification may be made by turning on an LED provided in the notifying module 70 or by audio output. Alternatively, a radio signal may be transmitted to the remote controller 30 and a message may be displayed on the display 33. The notifying module 70 may be arranged, for example, in the vicinity of the illumination device 40 so that it can be recognized which illumination device corresponds to a battery for which an amount of remaining energy has decreased.

As described above, according to the third modification, a decrease in the amount of remaining energy of the internal battery 21 can be reported to the user to prompt the user to charge the internal battery 21. When the decrease in the amount of remaining energy is notified, the user can remove and charge the internal battery 21, or supply electric power from the remote controller 30 to charge the internal battery 21 as in the second modification.

### Fourth Embodiment

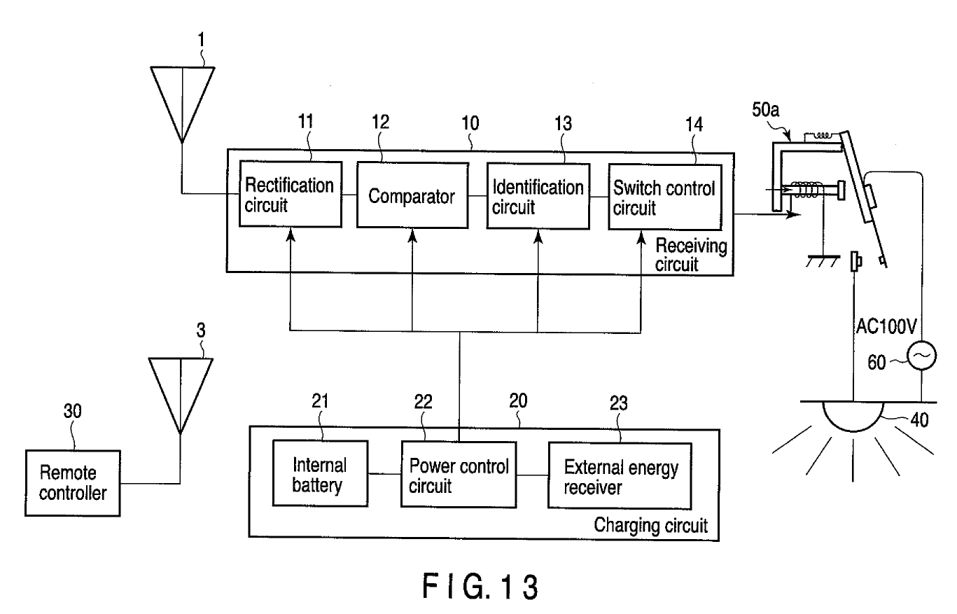

FIG. 13 is an exemplary view showing a configuration of the illumination control system according to a fourth modification. In this modification, an electrically controllable latching relay 50a is used as the switch 50, as shown in FIG. 13.

In the case where the battery in the power source 34 of the remote controller 30 is discharged, in the case where the user has lost the remote controller 30, or in the case where the remote controller 30 is not at hand, the remote controller 30 cannot be used. In such a case, turning the illumination device 40 on or off can also be controlled by operating an operation switch in the latching relay 50a provided, for example, on a wall.

A mechanical switch may be used instead of the latching relay 50a. When the mechanical switch is used, the operator needs to directly change the switch manually.

As described above, according to the fourth modification, turning the illumination device 40 on or off can be controlled even when the remote controller 30 cannot be used.

### Fifth Embodiment

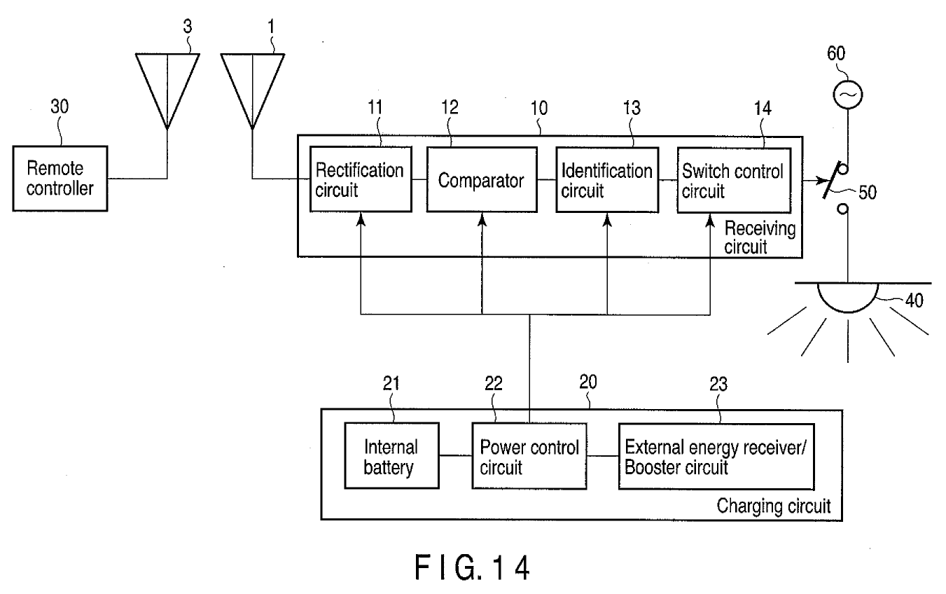

FIG. 14 is an exemplary view showing a configuration of the illumination control system according to a fifth modification. As shown in FIG. 14, the external energy receiver 23 comprises a booster circuit.

In order to charge the internal battery 21, voltage higher than the voltage of the internal battery 21 needs to be provided. Even when the external energy receiver 23 can generate merely voltage lower than the voltage of the internal battery 21, the voltage can be boosted up by the booster circuit to enable charging.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules, or components on one or more computers, such as servers. While the various modules are illustrated separately, they may share some or all of the same underlying logic or code.

What is claimed is;

1. An illumination control device for controlling remotely an illumination device, comprising:
a signal detection module configured to detect a control signal from a remote controller with a rectification circuit configured to receive a bias voltage;
a switch controller configured to turn a switch of the illumination device on or off in accordance with the signal detected by the signal detection module;
an energy receiver configured to receive energy and to convert the energy into electricity;
an internal battery configured to store the electricity converted by the energy receiving module; and
a power supply module configured to supply voltage to the signal detection module and the bias voltage either from the electricity converted by the energy receiving module or from the electricity stored in the internal battery.

2. The illumination control device of claim 1,
wherein the illumination device has a unique identification code (ID), and
the illumination control device further comprising an identification module configured to identify an identification code (ID) in the control signal detected by the signal detection module and to cause the switch control module to turn the switch on or off when the identified ID matches the ID of the illumination device.

3. The illumination control device of claim 1, wherein the energy receiver is configured to receive energy generated by the illumination device and to convert the energy into electricity.

4. The illumination control device of claim 3, wherein the energy receiver is located in a vicinity of the illumination device.

5. The illumination control device of claim 1, wherein the energy receiver comprises a photoelectric convertor and configured to convert light generated by the illumination device into electricity.

6. The illumination control device of claim 1, wherein the energy receiver is configured to receive from an antenna electromagnetic radiation generated by the illumination device and to convert energy of the electromagnetic radiation into electricity.

7. The illumination control device of claim 6, wherein the antenna comprises an inductor-capacitor (LC) parallel resonance circuit comprising an inductor and a capacitor.

8. The illumination control device of claim 1, further comprising a remaining energy detection module configured to detect an amount of remaining energy of the internal battery,
wherein the switch controller is configured to control the switch in order to turn the illumination device on when the amount of remaining energy of the internal battery detected by the remaining energy detection module is less than or equal to a predetermined threshold.

9. The illumination control device of claim 1, wherein the energy receiver is configured to receive energy from a signal transmitted from the remote controller, and to convert the energy into electricity.

10. The illumination control device of claim 1, further comprising:
a remaining energy detection module configured to detect an amount of remaining energy of the internal battery; and
a notifying module configured to notify a decrease in the amount of remaining energy when the amount of remaining energy of the internal battery detected by the remaining energy detection module is less than or equal to a predetermined threshold.
